(19) United States
(12) Patent Application Publication
(10) Pub. No.: US 2008/0152403 A1
(43) Pub. Date: Jun. 26, 2008

(54) Fixing device and image forming apparatus

(75) Inventors: Toshiyuki Miyata, Kanagawa (JP); Daisuke Yoshino, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/808,998

(22) Filed: Jun. 14, 2007

(30) Foreign Application Priority Data
Dec. 21, 2006 (JP) P2006-344843

(51) Int. Cl. G03G 15/20

(52) U.S. Cl. 399/329; 399/333

(57) ABSTRACT

A fixing device that fixes a toner image on a recording material by use of a toner containing a release agent, the fixing device comprising: a fixing member having an outermost layer of a fluorinated resin; and a pressurizing rotary member placed in contact under pressure with the fixing member and forming a nip site where the recording material is to pass, wherein the outermost layer of the fixing member has a surface roughness (Ra) of about 0.05 to about 0.15 μm.

### CROSS-REFERENCE TO RELATED APPLICATIONS

This application is based on and claims priority under 35 USC 119 from Japanese Patent Application No. 2006-344843 filed Dec. 21, 2006.

### BACKGROUND

(i) Technical Field

The present invention relates to fixing devices and more particularly to a fixing device or the like for use on an image forming apparatus.

(ii) Related Art

The image forming apparatus conventionally is to form an image by developing the electrostatic latent image, formed on an image-carrying surface, into a toner image, transferring the toner image onto a recording medium through an intermediate transfer member, and then fixing it on a recording medium through use of a heater fixing mechanism.

### SUMMARY

According to the invention, there is provided a fixing device comprising: a fixing member having an outermost layer of a fluorinated resin; and a pressurizing rotary member placed in contact under pressure with the fixing member and forming a nip site where the recording material is to pass, the outermost layer of the fixing member having a surface roughness (Ra) of about 0.05 to about 0.15 μm, and the fixing device fixing a toner image on a recording material by use of a toner containing a release agent.

### BRIEF DESCRIPTION OF THE DRAWINGS

Exemplary embodiments of the present invention will be described in detail based on the following figure, wherein:

FIG. 1 is a schematic construction diagram showing an image forming apparatus according to an exemplary embodiment;

FIG. 2 is a sectional view showing a schematic structure of a fixing device in the exemplary embodiment;

FIG. 3A is a figure explaining a relationship between a surface roughness (Ra) of the fixing belt and an image gloss; and

FIG. 3B is a figure explaining an aging change of the surface roughness (Ra) at between the initial stage and after the passes of 100 k of sheets.

### DETAILED DESCRIPTION

Now explanation will be made on an exemplary embodiment for carrying out the present invention. Note that the invention is not limited to the following exemplary embodiment but can be carried out with various modifications within the scope of the gist thereof. The drawings in use are for explaining the exemplary embodiment but not representative of actual size.

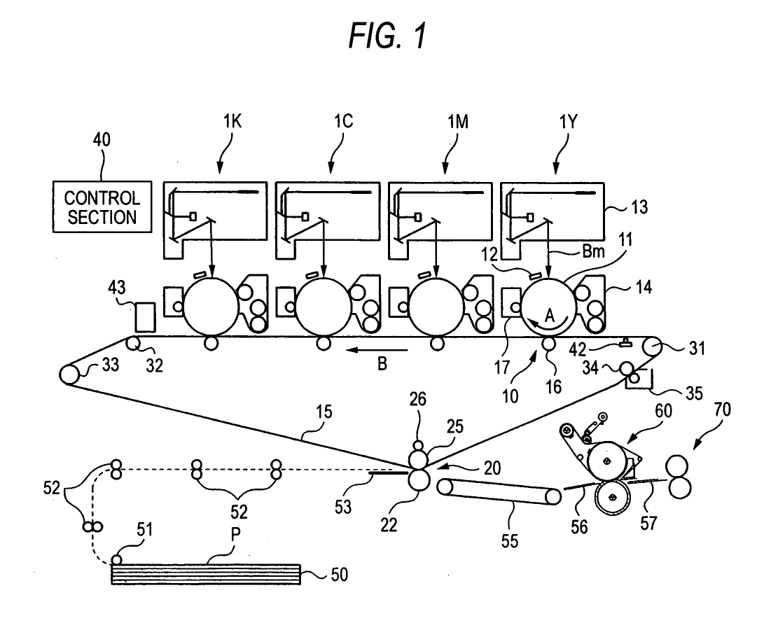

FIG. 1 is a schematic arrangement showing an image forming apparatus to which the exemplary embodiment is applied. The image forming apparatus, shown in FIG. 1, is of an intermediate transfer scheme generally called the tandem type, which includes a plurality of image forming units 1Y, 1M, 1C, 1K to form toner images in respective color components according to a xerographic scheme, a primary transfer part 10 where to transfer (primarily transfers), in order, the toner images in respective color components formed by the image forming units 1Y, 1M, 1C, 1K onto an intermediate transfer belt 15, a secondary transfer part 20 where to transfer the superposed toner images transferred on the intermediate belt 15 collectively onto a recording sheet P, i.e. recording material (recording paper), a fixing device 60 to fix the secondary-transferred images onto a recording sheet P, and a sheet feed roller 70 serving as a sheet feeder to transport the image-fixed recording sheet P to the downstream. Besides, provided also a control section 40 that controls the operations of the devices (sections).

In the exemplary embodiment, the image forming unit 1Y, 1M, 1C, 1K have a photosensitive drum 11 rotating-in a direction of arrow A, around which are arranged xerographic devices, i.e. a charging device 12 that charges the photosensitive drum 11, a laser exposure device 13 that writes an electrostatic latent image onto the photosensitive drum 11 (in the figure, an exposure beam is shown at reference Bm), a development device 14 containing a toner in a color component and visualize the electrostatic latent image of the photosensitive drum 11 through use of the toner, a primary transfer roller 16 that transfers, at a primary transfer part 10, the toner image in a color component formed on the photosensitive drum 11 onto the intermediate transfer belt 15, and a drum cleaner 17 that removes the remaining toner out of the photosensitive drum 11, in the order. Those image forming units 1Y, 1M, 1C, 1K are arranged nearly straight in the order of yellow (Y), magenta (M), cyan (C) and black (K) from the upstream with respect to the intermediate transfer belt 15.

The intermediate transfer belt 15, serving as an intermediate transfer member, is to be circulatively driven (circulated) on various rollers at a predetermined rate in a direction of arrow B shown in FIG. 1. Those various rollers include a drive roller 31 that is to be driven by a motor (not shown) excellent in rotating at a constant rate and to circulate the intermediate transfer belt 15, a support roller 32 that sustains the intermediate transfer belt 15 extending nearly straight along the arrangement direction of the photosensitive drums 11, a tension roller 33 that gives a constant tension to the intermediate transfer belt 15 and serves as a correction roller to prevent the irregular movement of the intermediate transfer belt 15, a backup roller 25 that is provided in the secondary transfer part 20, and a cleaning backup roller 34 that is provided in a cleaning part to scrape the remaining toner out of the intermediate transfer belt 15.

The primary transfer part 10 is made up with a primary transfer roller 16 arranged opposite to the photosensitive drum 11 with respect to the intermediate transfer belt 15. The primary transfer roller 16 is arranged in contact, under pressure, with the photosensitive drum 11 through the intermediate transfer belt 15. Furthermore, the primary transfer roller 16 is to be applied with a voltage (primary transfer bias) in a polarity opposite to the charge polarity (assumed minus in polarity, from now on) of the toner. Due to this, the toner images on the respective photosensitive drums 11 are to be electrostatically attracted, in order, onto the intermediate transfer belt 15, to form a superposed toner image on the intermediate transfer belt 15.

The secondary transfer part 20 is made up with the secondary transfer roller 22 arranged on the intermediate transfer belt 15 at its toner-image carrying surface and a backup roller 25. The backup roller 25 is arranged on the intermediate transfer belt 15 at its backside, to constitute a counter electrode to the secondary transfer roller 22, and abutted against with a metal-make power-feed roller 26 applied stably with a secondary transfer bias.

Meanwhile, the secondary transfer roller 22 is arranged urged on the backup roller 25 through the intermediate transfer belt 15. Furthermore, the secondary transfer roller 22 is grounded to form a secondary transfer bias with the backup roller 25 so that a toner image can be secondarily transferred onto the recording sheet P being fed to the secondary transfer part 20.

In the downstream of the secondary transfer part 20 as to the intermediate transfer belt 15, an intermediate transfer belt cleaner 35 is provided for contact therewith so that the intermediate transfer belt 15, after a secondary transfer, can be removed of the remaining toner and paper powder and cleaned at the surface thereof. In the upstream of the yellow image forming unit 1Y, a reference sensor (home-position sensor) 42 is arranged to generate a reference signal giving a reference for the image forming unit 1Y, 1M, 1C, 1K to take the timing of image formation. In the downstream of the black image forming unit 1K, an image concentration sensor 43 is arranged to regulate the image quality. The reference sensor 42 is to generate a reference signal by recognizing a predetermined mark provided on the backside of the intermediate transfer belt 15. Recognizing the reference signal, the control section 40 instructs the image forming units 1Y, 1M, 1C, 1K to start a forming of an image.

The image forming apparatus of this exemplary embodiment has a sheet feed system including a sheet tray 50 containing recording sheets P, a pickup roller 51 that takes up in predetermined timing a recording sheet P stacked in the sheet tray 50 and feeds it, a feed roller 52 that feeds the recording sheet P drawn out by the pickup roller 51, a feed chute 53 that supplies the recording sheet P transported by the feed roller 52 to the secondary transfer part 20, a conveyor belt 55 that delivers, to the fixing device 60, the recording sheet P fed after secondarily transferred at the secondary transfer roller 22, a fixing inlet guide 56 that introduce the recording sheet P to the fixing device 60, and an outlet guide 57 that introduces, to the sheet-feed roller 70, the recording sheet P after fixed at the fixing device 60.

Now explanation is made on the basic process of forming an image on the image forming apparatus to which the exemplary embodiment is applied.

In the FIG. 1 image forming apparatus, the image data, outputted from a not-shown image reader (IIT), a not-shown personal computer (PC) or the like, is subjected to a predetermined image processing by a not-shown image processing system (IPS), and then produced as an image by means of the image forming units 1Y, 1M, 1C, 1K. The IPS makes a predetermined image processing on the input reflectance data, including shooting correction, positional deviation correction, light-intensity/color-space conversion, gamma correction, frame removal and color editing and various image edits such as movement editing. The image data thus processed is converted into color-material-based grayscale data in four colors, i.e. Y, M, C and K, and outputted to the laser exposure device 13.

The laser exposure device 13 is to illuminate an exposure beam Bm, emitted from a semiconductor laser, onto the photosensitive drum 11 of the image forming unit 1Y, 1M, 1C, 1K, according to the color-material-based grayscale data inputted. In the photosensitive drum 11 of the image forming unit 1Y, 1M, 1C, 1K, the surface thereof is charged by the charger device 12. Then, the surface is scan-exposed by the laser exposure device 13, to form an electrostatic latent image thereon. The formed electrostatic latent image is developed as Y, M, C and K color-based toner images by the developing devices 14 of the image forming units 1Y, 1M, 1C, 1K.

The toner image, formed on the photosensitive drum in the image forming unit 1Y, 1M, 1C, 1K, is transferred onto the intermediate transfer belt 15, in the primarily transfer part 10 where the photosensitive drum 11 is in abutment against the intermediate transfer belt 15. Specifically, at the primary transfer part 10, the primary transfer roller 16 applies a voltage (primary transfer bias), opposite in polarity (plus polarity) to the charge polarity of the toner, to the base material of the intermediate transfer belt 15, thus effecting a primary transfer by superposing toner images, in order, on the surface of the intermediate transfer belt 15.

After primarily transferring the toner images, in order, onto the surface of the intermediate transfer belt, the intermediate transfer belt 15 moves to deliver the toner images to the secondary transfer part 20. When the toner images are delivered to the secondary transfer part 20, the sheet feed system rotates the pickup roller 51 in timing with the transport of the toner images to the secondary transport site 20, to supply a recording sheet P in a predetermined size out of the sheet tray 50. The recording sheet P, supplied by the pickup roller 51, is fed by the transport roller 52 thus reaching the secondary transfer part 20 through the feed chute 53. Before reaching the secondary transfer part 20, the recording sheet P is once stopped. By rotating a register roller (not shown) in movement timing with the intermediate transfer belt 15 carrying thereon toner image, the toner image is put in position with the recording sheet P.

In the secondary transfer part 20, the secondary transfer roller 22 is pushed against the backup roller 25 through the intermediate transfer belt 15. At this time, the recording sheet P, fed in timing, is put to between the intermediate transfer belt 15 and the secondary transfer roller 22. On this occasion, when the power feed roller 26 applies a voltage (secondary transfer bias) same in polarity (negative polarity) as the charge polarity of the toner, an electric field is formed at between the secondary transfer roller 22 and the backup roller 25. The unsettled toner image, on the intermediate transfer belt 15, is electrostatically transferred collectively onto the recording sheet, in the secondary transfer part 20 where pressed between the secondary transfer roller 22 and the backup roller 25.

Then, the secondary transfer roller 22 conveys the recording sheet P, the toner images are electrostatically transferred, in a state stripped off the intermediate transfer belt 15, directly onto the conveyor belt 55 provided downstream of the secondary transfer roller 22 with respect to a sheet-feeding direction thereof. The conveyor belt 55 transports the recording sheet P to the fixing device 60, at the optimal rate matched to the feed rate through the fixing device 60. The unsettled toner images, on the recording sheet P delivered to the fixing device 60, is processed for fixing with heat and under pressure, thus being settled on the recording sheet P. The recording sheet P, formed with a fixed image, is conveyed through a sheet feed roller 70 to a sheet tray (not shown) provided at the outlet of the image forming apparatus.

After completing the transfer to the recording sheet P, the remaining toner on the intermediate transfer belt 15 is moved by the circulation of the intermediate transfer belt 15 and removed out of the intermediate transfer belt 15 by means of the cleaning backup roller 34 and the intermediate transfer belt cleaner 35.

(Fixing Device)

The fixing device 60 is now explained.

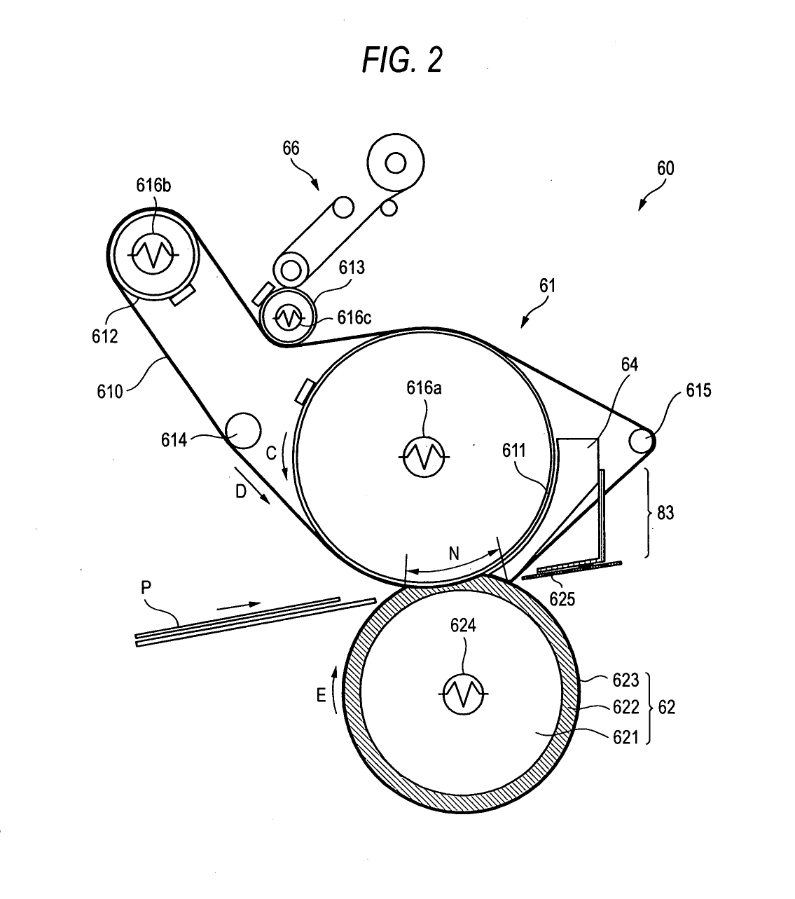

FIG. 2 is a sectional view showing a schematic arrangement of the fixing device 60 in the exemplary embodiment. The fixing device 60 has, as a main component, a fixing-belt module 61 serving as a pressurizing member and a heating member. Meanwhile, a pressurizing roller 62, formed in a roller form, is provided as a main component, as an example a pressurizing rolling element arranged in contact under pressure with the fixing-belt module 61 and forming a nip site N where to pass a recording sheet P, i.e. a recording material. Incidentally, in the downstream of the fixing device 60, the sheet feed roller 70 (see FIG. 1) is provided to feed the recording sheet P, the fixed image is formed, to the sheet tray (not shown) provided at the outlet of the image forming apparatus.

The fixing-belt module 61 has a fixing belt (heat-resistive endless belt) 610, i.e. fixing member, that circulates in direct contact with the pressurizing roller 62, a fixing roller 611 formed cylindrical to rotatively drive the fixing belt 610 in a direction of arrow C while tightening it, and a tension roller (steering roller) 612 serving as a tightening member that lays across the fixing belt 610 from the inner. The fixing-belt module 61 has a tension roller 613 that tighten the tension belt 610 from the outer, and a position rectifier roller 614 that rectifies the position of the fixing belt 610 by rotating the tension belt 610 due to the circulation in a direction of arrow D at between the fixing roller 611 and the tension roller 612. Here, the fixing belt 610 is a heat-resistive endless belt having, in a surface, an outermost layer formed of fluorocarbon resin.

Furthermore, the fixing-belt module 61 has a stripper pad 64, as an example of a stripper member, arranged in a position nearby the fixing roller 611 and downward in the nip site N where the fixing-belt module 61 and the pressurizing roller 62 are in mutual contact under pressure.

Meanwhile, the fixing-belt module 61 has a tension roller (idler roller) 615 that tighten the fixing belt 610 in a position downstream of the nip site N. Besides, the fixing-belt module 61 has a cleaning web 66 to clean the surface of the tension roller 613.

The fixing belt 610 is moved (circulated) in a direction of arrow D by the rotation of the fixing roller 611.

The fixing roller 611 is rotated in a direction of arrow C, on a drive force of from predetermined drive means (not shown). Meanwhile, a heater 616a is arranged as a heating source at the inside of the fixing roller 611.

Meanwhile, the tension roller 612 is circularly cylindrical in form, within which a heater 616b is arranged as a heating source. Accordingly, the tension roller 612 serves to tighten the fixing belt 610 and also to heat up the fixing belt 610 at the inner surface thereof. Spring members (not shown) are arranged at both ends of the tension roller 612, to push the fixing belt 610 outwardly. Thus, the fixing belt 610 is given a tension entirely thereof.

The tension roller 613 is circularly cylindrical in form and arranged therein with a heater 616c as a heating source. Thus, the tension roller 613 serves to give a tension to the fixing belt 610 and heat up the fixing belt 610 at the outer surface thereof. Therefore, the exemplary embodiment employs a structure to heat up the fixing roller 610 by means of the fixing roller 611, tension roller 612 and tension roller 613.

The pressurizing roller 62 has a circular cylindrical roller 621 as its basic member. An elastic layer 622 and a release layer 623 are laid in the order of from the basic member, thus making up a soft roller. Meanwhile, the pressurizing roller 62 is arranged in a manner pushed by the fixing-belt module 61. This is rotated in a direction of arrow E following the fixing roller 611 by the rotation of the fixing roller 611 of the fixing-belt module 61 in the direction of arrow C. Meanwhile, the pressurizing roller 62 has a heater 624 as a heating source therein. By the heater 624, the pressurizing roller 62 is to be heated up-to a predetermined temperature.

The fixing device 60 has a guide member 83 that introduces a recording sheet P of from the nip site N to the sheet outlet device (not shown). The guide member 83 is attached distant a predetermined spacing from the fixing belt 610 and for swinging, together with the stripper pad 64, about the axis of the fixing roller 611. Meanwhile, a strip claw 625 is attached under the guide member 83 at its underside.

Here, the stripper pad 64 is arranged at around a downstream of the nip site N and with a predetermined spacing from the fixing roller 611. Thus, it pushes the fixing belt 610 on the surface of the pressurizing roller 62.

The stripper pad 64 is formed nearly in an arcuate form, in section, extending along a circumference of the fixing roller 611, and arranged axially of the fixing roller 611 in a vicinity of a downstream of the nip site N. The fixing belt 610, in a portion passed the nip site N, is to circulate conforming to the stripper pad 64 at its side surface. Thus, the fixing belt 610 is changed in its movement direction by the stripper pad 64 in a manner being sharply bent toward the tension roller 615. The recording sheet P is stripped off the fixing belt 610 by virtue of its elasticity. The recording paper P separated from the fixing belt 610 is guided in its travel direction by means of the guide member 83 arranged downstream of the nip site N.

Incidentally, the stripper pad 64 in the exemplary embodiment is a block member generally in an arcuate form in section formed, say of a rigid material, e.g. SUS metal or resin. Meanwhile, the stripper pad 64 is arranged to urge the pressurizing roller 62 at a predetermined load (e.g. 10 kgf) over a predetermined widthwise region (e.g. a width of 2 to 10 mm along the movement of the fixing belt 610).

(Toner)

The color toner, in a color component to be developed by the development device 14 (see FIG. 1) of the image forming unit 1Y, 1M, 1C, 1K in the exemplary embodiment, contains a suitable additive for the purpose, e.g. a solidified resin such as a polyester resin, a coloring agent such as a dye or a sublimation dye, a release agent such as a wax, charge control material or the like. Particularly, the toner used in the exemplary embodiment contains a release agent (contained or added), to act as an oil strainer capable of obtaining the releasability between the recording sheet P the toner image is fixed and the fixation member without the provision of a release-material applicator device.

The method of producing such a toner is not especially limited but may be a knead-and-crush process that a solidified resin, a coloring agent and an additive are knead together and then crushed, a suspension polymerization process that a coloring agent, a release agent, etc. are suspended together with a polymeric monomer into polymerization with the polymeric monomer, a dissolving-and-suspension process that toner materials of a solidified resin, a coloring agent, a release agent, etc. are dissolved in an organic solvent and dispersed in a suspension state in a water-based solvent and then removed of the organic solvent, an emulsified polymerization aggregation amalgamation process that a resin is prepared by emulsified polymerization and hetero-aggregated together with a dispersion liquid of pigments, release agent etc. and the amalgamated.

(Release Agent)

The toner, used in the exemplary embodiment, contains a release agent such as a wax. Generally, by containing a release agent in the toner, a broader fixing latitude is to be obtained even where not using a release oil on the surface of the fixing belt 610. Here, fixing latitude refers to a temperature range of between a lower temperature (lowest fixing temperature) at which an unfixed toner image is to fix on a recording sheet P and a higher temperature (offset occurring temperature) at which the toner image becomes not released from the fixing belt when the temperature of the fixing belt 610 is changed.

The addition amount of the release agent, usually, is suitably about 0.5 to about 50 percent by weight relative to the toner, preferably about 1 to about 30 percent by weight, more preferably 5 to 15 percent by weight. Within the above range, release-agent addition effect is obtainable. Meanwhile, fluidity and charge characteristic improves because the exposure degree at the toner surface is provided proper.

Such a release agent may be, say, a crystalline wax, and waxes. Specifically, crystalline wax may be a low-molecular polyolefin wax, such as of polyethylene, polypropylene or polybutene. Waxes may be a vegetable wax, such as carnauba wax, cotton wax, wooden wax or rice wax; animal wax such as yellow beeswax or lanoline; mineral wax such as ozokerite or selsyn; petroleum wax such as paraffin, microcrystalline or petrolatum.

Besides natural waxes, it is possible to use also a synthetic carbon-hydride wax of Fischer-Tropsch wax or polyethylene wax, or a synthetic wax of 12-hydroxy amido stearate, amido stearate, phthalic anhydride imide, fatty acid amido such as chlorinated hydrocarbon, ester, ketone and ether.

Furthermore, it is possible to use polyacrylate polymer such as poly n-stearyl methacrylate, poly n-lauryl methacrylate.

Of the release agents, a crystalline wax may be preferred. The crystalline wax has a melt point of usually about 40 to about 50° C., preferably about 50 to about 120° C. By using a crystalline wax having a melt point somewhat lower than the melt point of a solidified resin in the toner, the crystalline wax effectively fuses earlier than the solidified resin. This improves the release characteristic, upon stripping, at the outlet of the nip site N of the fixing device 60.

Incidentally, the solidified resin in the toner is not especially limited but can use a material for general use as a solidified resin for a toner. Such a solidified resin may be a polyester resin, a styrene resin, an acrylic resin, a styrene-acrylic resin, a silicone resin, an epoxy resin, a diene resin, a phenol resin, ethylene-vinyl acetate resin or the like.

(Fixing Belt)

The fixing belt 610 is now explained. As shown in FIG. 2, the fixing belt 610 is to circulate, as a fixation member, in direct contact under pressure with the pressurizing roller 62.

The fixing belt 610, in the exemplary embodiment, is a flexible, heat-resistive endless belt having a predetermined circumferential length and width. Usually, it is in a multi-layer structure having a base layer formed of a polyimide resin having a thickness of approximately 80 μm, an elastic layer formed of a 200-μm thick silicone rubber laid over the surface of the base layer (on the outer peripheral surface), and an outermost layer formed of a fluorinated resin and having a thickness of 30 μm on the elastic layer. Herein, the elastic layer is provided to improve the image quality particularly for a color image. Incidentally, the fixing belt 610 can be structured by suitably selecting its material, thickness, hardness, etc. in accordance with the apparatus design conditions of use purpose, use condition and the like.

In the exemplary embodiment, the outermost layer of the fixing belt 610 can be formed with a fluorinated resin tube, fluorinated resin coating or the like. Among these, it is preferable to fit a fluorinated resin tube, previously formed in a tube form, over the surface of the fixing belt 610 in view of releasability from the recording sheet P and wear resistance.

The fluorinated resin tube is, say, a tube of polytetrafluoro-ethylene resin (PTFE), tetrafluoroethylene-perfluoroalkyl vinyl-ether copolymer (PFA), ethylene fluoride-propylene copolymer resin (FEP), polyvinylidine resin (PVDF), polyvinyl fluoride resin. Of these, a PFA tube is particularly preferred.

Incidentally, where using a coating material of a fluorinated resin, it is satisfactory to lay a latex, etc. of a polytetrafluoro-ethylene resin (PTFE) over the base layer or over the outer peripheral surface of the elastic layer.

The outermost layer preferably has a thickness of 20 to 40 μm. In case the outermost layer is excessively thin, the fixing belt 610 tends to lower in its durability.

(Outermost-Layer Surface Roughness (Ra))

The fixing belt 610 in the exemplary embodiment may have an outermost layer having a surface roughness (Ra) of about 0.05 to about 0.15 μm, preferably about 0.1 to about 0.12 μm.

Here, surface roughness (Ra) is in terms of mean roughness as defined under JIS (JIS B 0601-1994) as to a parameter of surface roughness.

In case the outermost layer has a surface roughness (Ra) excessively small, wear is caused in the outermost layer by sheet pass, to increase the surface wear. Because of a chronological change of surface roughness (Ra) in the outermost layer, there encounters a tendency of image gloss change with the passage of time. In case the outermost layer surface roughness (Ra) is excessively great, the fixing belt 610 deteriorates in its surface smoothness, making it difficult to gain a high gloss initially.

Namely, where the surface roughness (Ra) of the fixing belt 610 is excessively as great as approximately 0.4 μm for example, there is almost a difficulty in obtaining a fixed image with gloss and quality for use in graphic art.

Meanwhile, the outermost layer formed fluorinated resin of the fixing belt 610 generally is generally worn by the slide with a recording sheet P. Because of a change of surface roughness (Ra) at between the initial and the passage of time, image gloss differs on the fixed image. Then, the aging change of surface roughness (Ra) is explained.

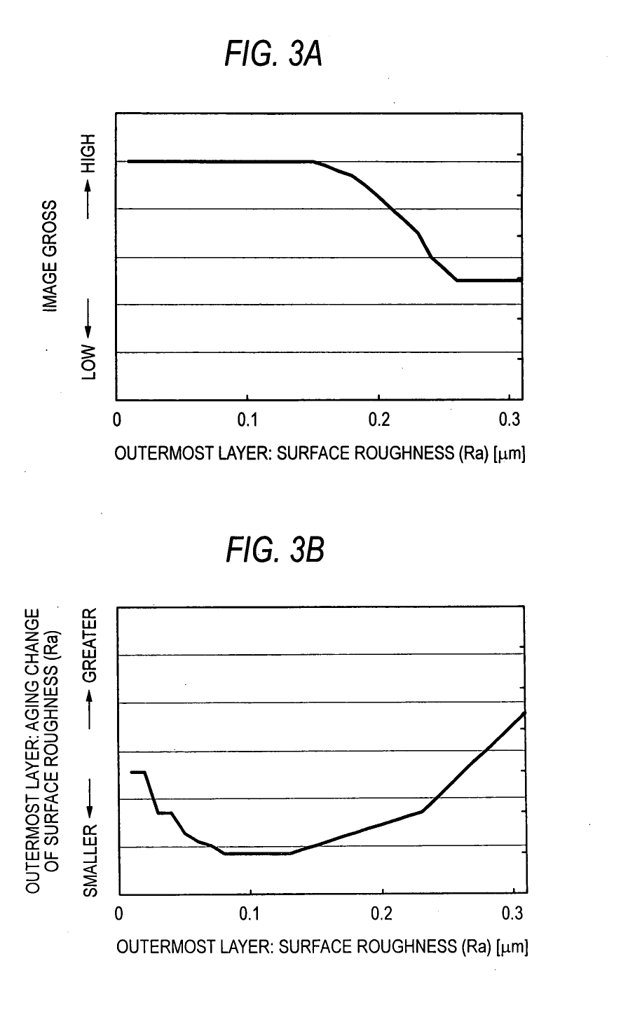

FIG. 3 is a figure explaining a relationship between a surface roughness (Ra) and an image gloss of the fixing belt 610 (FIG. 3A) and an aging change of the surface roughness (Ra) at between the initial stage and after the passes of 100 k of sheets (FIG. 3B).

As shown in FIG. 3A, where the fixing belt 610 (see FIG. 2) in the exemplary embodiment has a surface roughness (Ra) of 0.15 or smaller, the fixing belt 610 is highly smooth at its surface, thus obtaining a fixed image with gloss. However, in the case the surface roughness (Ra) is excessively as great as over 0.15, the smoothness abruptly lowers in the surface of the fixing belt 610, thus deteriorating the image gloss.

Meanwhile, as shown in FIG. 3B, where the initial surface roughness (Ra) is excessively small (approximately 0.05 μm or smaller) in the outermost layer, an aging change is observed in the surface roughness (Ra) because of an increased surface roughness (Ra) after the passes of 100 k sheets. Furthermore, in case the initial surface roughness (Ra) is excessively great (at a value exceeding approximately 1.5 μm) in the outermost layer, an aging change is also observed in the surface roughness (Ra) because of an increased surface roughness (Ra) after the passes of 100 k sheets.

Meanwhile, where the initial surface roughness (Ra) is in a range of approximately 0.05 to 1.5 μm in the outermost layer, there is less change in the surface roughness (Ra) after the passes of 100 k sheets wherein it can be seen that aging change is less encountered in the surface roughness (Ra). Consequently, it is possible to obtain a quality, reliable image with less aging change of image gloss.

In this manner, with the repetition of passes of sheets, the outermost layer formed of a fluorinated resin changes in its surface roughness (Ra) due to the wear at the surface in the outermost layer by means of recording sheets P. Thus, image gloss changes with the passage of time.

However, where the initial surface roughness (Ra) is within a range of about 0.05 to about 0.15 μm, the surface roughness (Ra) does not changes if repeating the passes of sheets, thus making it possible to obtain a fixed image with gloss at from the initial stage of fixing.

Incidentally, in the exemplary embodiment, although the feed rate of the recording sheet P as a recording material is not especially limited, it may be preferably about 200 mm/s or greater in the usual case.

Using three types of fixing belts 610 (see FIG. 2) that are different in the outermost layer roughness (Ra) (Ra: 0.1 μm, 0.3 μm, 0.01 μm) based on FIG. 3, experiment was conducted on the passes of 1000 k sheets by means of the fixing device 60. The initial image gloss, the change of surface-roughness (Ra) and the change of image gloss were evaluated based on the following criterions. The result is shown in Table 1.

(i) initial image gloss

O: fixed image obtained with high gloss

x: fixed image not obtained with high gloss

(ii) surface roughness (Ra) change

O: smaller surface-roughness (Ra) change after passes of 100 k sheets

x: greater surface-roughness (Ra) change after passes of 100 k sheets

(iii) image gloss change

O: fixed image obtained with high gloss after passes of 100 k sheets

x: fixed image not obtained with high gloss after passes of 100 k sheets.

Incidentally, the fixing belt 610 used a flexible endless belt having a circumferential length of 314 mm and a width of 340 mm. The fixing belt 610 is structured with a base layer formed of polyimide resin having a thickness of 80 μm, an elastic layer formed of silicone rubber laid over the surface (on the outer peripheral surface) of the base layer, and an outermost layer formed by a tube of tetrafluoroethylene-perfluoroalkyl vinyl-ether copolymer (PFA) laid over the elastic layer and having a thickness of 30 μm.

As for surface roughness (Ra) in the outermost layer, a PFA tube previously formed is fit over the elastic layer thus forming an outermost layer. Then, the outermost layer is treated by honing at its surface to a predetermined surface roughness (Ra). The outermost layer of the fixing belt 610 was measured for its surface roughness (Ra) in the outermost layer, by use of SURF COM (Tokyo Seimitsu Co., Ltd.).

Here, any of dry and wet schemes may be applied in honing. The wet scheme of honing is a method to suspend a powder-formed abrasive in a liquid such as water and to spray it at high rate onto an outermost layer of fluorinated resin thereby causing a roughening, wherein surface roughness (Ra) can be regulated depending upon spray pressure, rate, abrasive quantity, type, form, size, hardness, specific gravity and suspension temperature, etc. Likewise, the dry scheme of honing is a method to cause a roughening by spraying an abrasive at high rate onto the outermost layer by means of air, wherein surface roughness can be regulated similarly to the wet scheme of honing. For the wet or dry scheme of honing, abrasive may use a particle of silicon carbide, alumina, iron or glass beads.

TABLE 1

After passes of
100k sheets

| | | Initial | Surface | |
|---|---|---|---|---|
| | surface | Initial | roughness | Image |
| | roughness | image | (Ra) | gloss |
| | (Ra) μm | gloss | change | change |
| Example 1 | 0.1 | ◯ | ◯ | ◯ |
| Comparative | 0.01 | ◯ | X | X |
| example 1 | | | | |
| Comparative | 0.3 | X | X | X |
| example 2 | | | | |

From the result of Table 1, it was confirmed that, the fixing belt 610 has a surface roughness (Ra) in a range of about 0.05 to about 0.15 μm (example 1), a fixed image may be obtained at from the initial stage of fixing and, at the same time, there is less change in the surface roughness (Ra) of the outermost layer even after the passes of 100 k sheets thus there is no change in the gloss on the fixed image.

Meanwhile, where a surface roughness (Ra) of the fixing belt 610 is smaller than 0.05 μm (comparative example 1), a fixed image is obtained with gloss in the initial stage of fixing. However, it can be seen that, after the passes of 100 k sheets, the surface roughness (Ra) of the outermost layer is greatly changed to change the fixed image gloss.

Meanwhile, where the surface roughness (Ra) of the fixing belt 610 exceeds 0.15 μm (comparative example 2), it can be seen that a gloss fixed image is not to be obtained at from the initial stage of fixing wherein the surface roughness (Ra) is greatly changed in the outermost layer after passes of 100 k sheets thus changing the gloss on the fixed image.

As described in detail so far, the fixing device 60 in the exemplary embodiment can obtain a fixed image with gloss and image quality wherein the surface roughness (Ra) of the fixing belt 610 can be reduced from changing in time. Furthermore, the fixing belt 610 and the sheet side edge can be relieved from being damaged by an incoming recording sheet P.

Incidentally, generally, where a fluorinated resin layer is provided on a surface of a fixation member, the damage, caused in a surface of the fixation member by the pass of a sheet, problematically results in a damage in a fixed image. Such an image damage is to be considered detected in a fixed image because of the difference of surface roughness (Ra) at between the damaged point in the surface of the fixation member and the other region thereof.

The exemplary embodiment may reduce the difference of surface roughness (Ra) at between a damaged point and another point of the fixation member, and hence may prevent against image damage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a fixing member having an outermost layer of a fluorinated resin; and
a pressurizing rotary member placed in contact under pressure with the fixing member and forming a nip site where the recording material is to pass,
the fixing device fixing a toner image on a recording material by use of a toner containing a release agent, and
the outermost layer of the fixing member having a surface roughness (Ra) of about 0.05 to about 0.15 μm.

2. A fixing device according to claim 1,
wherein the outermost layer is provided by fitting a fluorinated resin tube formed in a tube form.

3. A fixing device according to claim 1,
wherein the outermost layer has a surface roughness (Ra) obtained by honing the outermost layer.

4. A fixing device according to claim 1,
wherein the recording material is fed at a rate of about 200 mm/s or greater.

5. A fixing device according to claim 1,
wherein the fixing member is a heat-resistive endless belt laid across by a fixing roller and a tension roller.

6. An image forming apparatus comprising a fixing device,
the fixing device comprising:
a fixing belt having an outermost layer of a fluorinated resin having a surface roughness (Ra) of about 0.05 to about 0.15 μm, the fixing belt being laid across by a fixing roller and a tension roller;
a pressurizing member arranged to urge the fixing roller through the fixing belt; and
a stripper member that urges the fixing belt on the pressurizing member, in a vicinity of a downstream of a pressure contact site of between the fixing roller and the pressurizing member, and strips a recording material out of the fixing belt,
the image forming apparatus forming an image on the recording material by use of a toner containing a wax, and
the fixing device fixing a toner image on the recording material by heat.
